(19) United States
(12) Patent Application Publication
(10) Pub. No.: US 2006/0243102 A1
(43) Pub. Date: Nov. 2, 2006

(54) Plumbing tool

(76) Inventor: Richard Howell Vines, Myrtle Beach, SC (US)

Correspondence Address: B. Craig Killough;Barnwell Whaley Patterson & Helms, LLC, P.O. Drawer H, Charleston, SC, 29402-0197, US

(21) Appl. No.: 11/398,120

(22) Filed: Apr. 5, 2006

Related U.S. Application Data
(60) Provisional application No. 60/675,573, filed on Apr. 28, 2005.

(51) Int. Cl. B25B 13/00; B25B 13/06

(52) U.S. Cl. 81/124.2; 81/121.1

(57) ABSTRACT

A universal tool for attaching and removing water inlet nuts from a toilet tank. The tool has an elongated body with a first end and a second end, and a longitudinal and continuous slot formed in the elongated body. The first end is formed to accept a type water inlet nuts, and the second end is formed to accept another type of water inlet nuts.

Applicant claims the benefit of Provisional Patent Application Ser. No. 60/675,573 filed Apr. 28, 2005.

### FIELD OF INVENTION

This invention relates to plumbing and plumbing tools.

### BACKGROUND OF THE INVENTION

Water inlet lines are connected to toilet tanks or water closets by nuts. The nuts are threaded fasteners that are typically formed of plastic. The two types of nuts in common use either have six bosses spaced 60° apart about a circular outside diameter, or opposing flanges that are spaced 180° apart about a circular diameter.

In common plumbing practice, these nuts are removed by channel locks or similar tools. There is a need for a tool that is specific to water inlet nuts of the types described, and which is universal, and can be used with both types of water inlet nuts.

### SUMMARY OF THE INVENTION

The present invention is a tool which can be used to attach and remove water inlet nuts of two types that are in common use.

### DESCRIPTION OF THE DRAWINGS

FIG. 1A in elevation shows the plumbing tool in position over a water line and being advanced upwardly.

FIG. 1B in elevation shows the plumbing tool in position over a water line and being advanced upwardly, with a second type of water inlet nut shown on the toilet tank.

FIG. 2 is a perspective view of a plumbing tool.

FIG. 3 is a perspective view of the plumbing tool of FIG. 2, shown as inverted.

FIG. 4 is a top plan view of the plumbing tool, with one type of water inlet nut shown therein.

FIG. 5 is a top plan view of the plumbing tool, showing a second type of water inlet nut present therein.

### DESCRIPTION OF THE PREFERRED EMBODIMENT

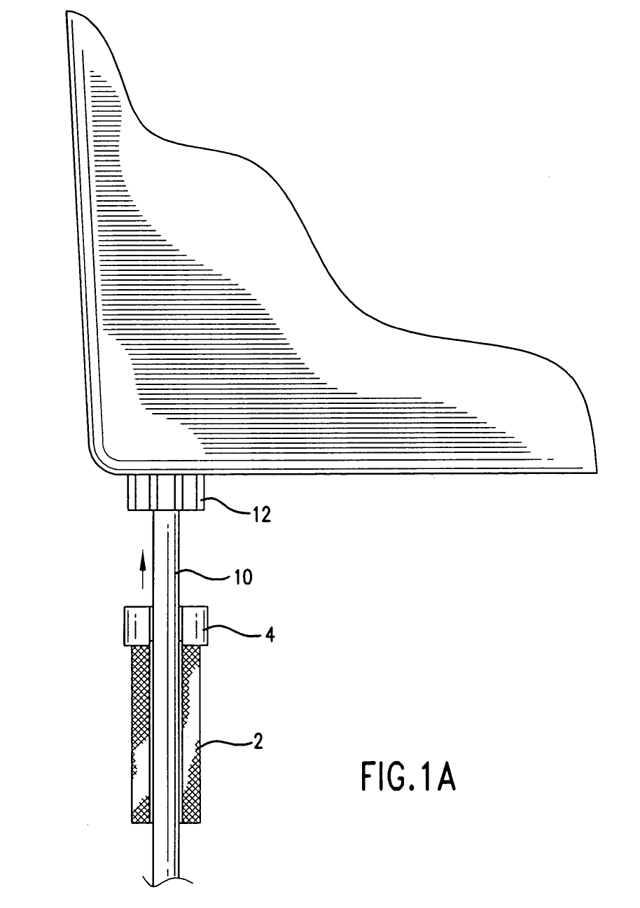

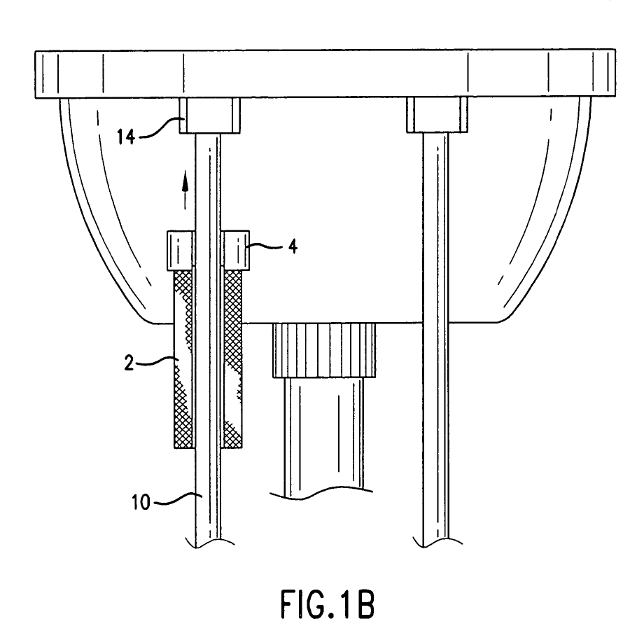

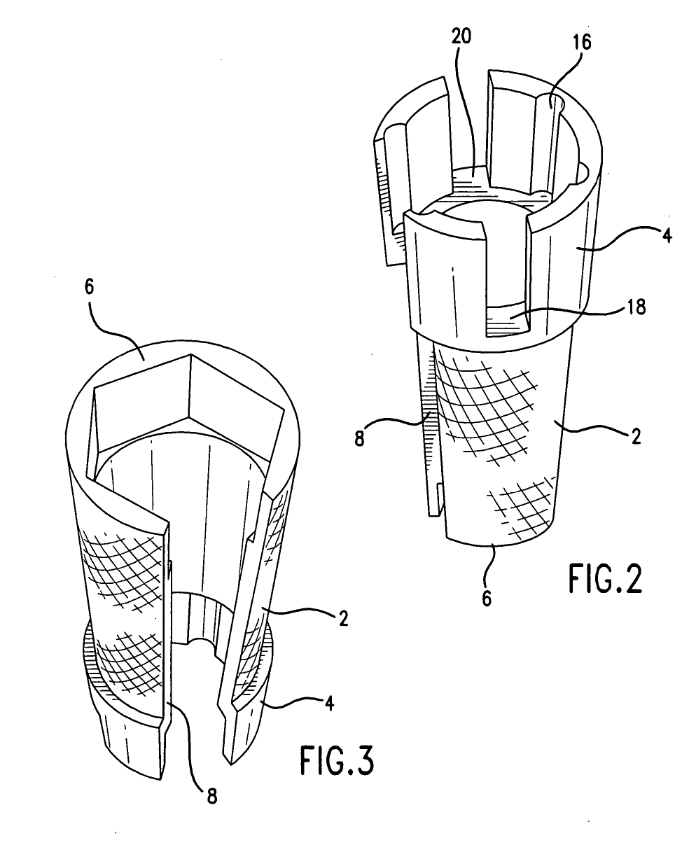

Referring now to the drawing figures, shown in FIG. 2, the plumbing tool has an elongated body. The body has a first end and a second end. In the preferred embodiment, the first end is enlarged relative to the second end. The elongated body has a split form therein from the first end to the second end, which allows a water line to be accepted within the interior of the elongated body. FIG. 1A; FIG. 1B.

The first end is adapted to accept both types of water inlet nuts for toilet tanks that are in common use. In a preferred embodiment, the first end is generally circular, or of cross radius, and shape when viewed from the top. Shown in FIG. 2, an interior wall of a first end of the elongated body has two arcuate slots formed therein. These arcuate slots may be spaced 60° apart, so that one boss of a water inlet nut is accepted into each slot. Two additional arcuate slots are formed opposite the arcuate slots on the back wall of the first end. These arcuate slots intersect the split of the first end of the elongated body, on opposite sides of the split. Two additional slots are formed in the first end. These slots oppose each other, and are spaced 80° apart, and each is 60° from the arcuate slot on the back wall, and an arcuate slot that intersects the split in the first end. In the preferred embodiment, these slots extend from an interior circular void of the first end, through an outside wall of the first end. However, if the first end is of sufficient outside diameter, the slots only need to be deep enough to accept the flanges of the water inlet nut 14.

In a preferred embodiment, the elongated body has a generally circular void that extends from a first end, through the body, and through the second end, so that the void is generally cylindrical and opens on each end, so as to accept a water line there through. An exterior of the body may be knurled, as shown in the drawing figures, so that the tool can be gripped either by hand, or by use of a separate tool, such as channel locks or vise grips.

FIG. 3 shows the device is inverted from FIG. 2. As shown in FIG. 3, the second end has a hexagonal box formed therein. The hexagonal box is open at the split for accepting water line. The hexagonal box may be used to engage hexagonally shaped nuts or similar fasteners.

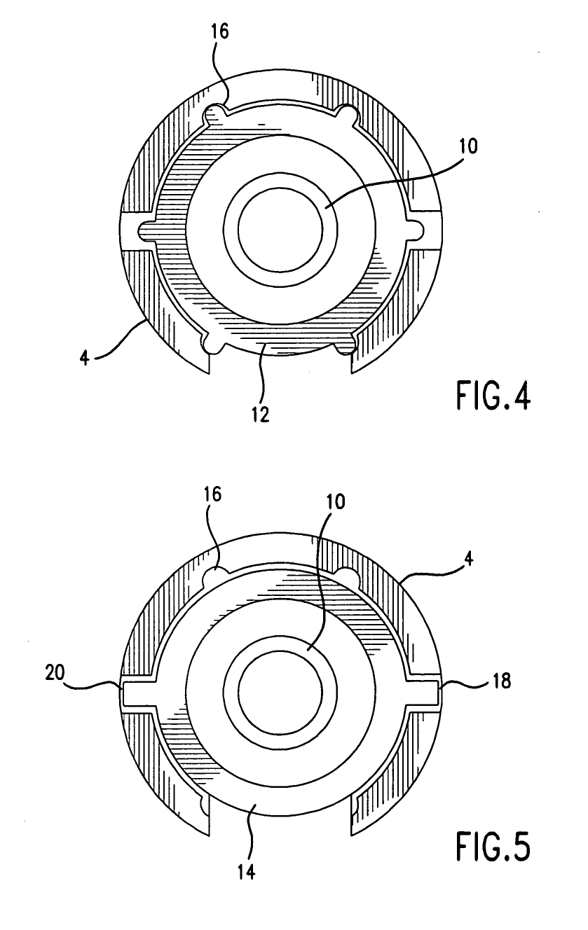

In use, the water line is inserted through the split and into the interior of the body. The device is inserted over the water line below the water inlet nut. The device may be used with water inlet nuts having two opposing flanges, or six bosses formed thereon. As demonstrated by FIG. 1A and FIG. 1B, the device is used substantially the same way, without regard to which of the types of nuts is present on the toilet tank. After the device is moved up, the first hand engages the water inlet nut. The difference in use between the device as shown in FIG. 1A and the device as shown in FIG. 1B, is that the opposing slots must engage the flanges as shown in FIG. 5, if a flange type water inlet nut is present. If a water inlet nut having six bosses is present, the water inlet nut engages the first end, and the two arcuate slots on the back wall, the two arcuate slots that intersect the split, and the opposing slots as shown in FIG. 4.

After the first end engages the water inlet nut, the water inlet nut is rotated to either, attach and tighten the water inlet nut or to loosen and remove the water inlet nut. The operator may then remove the water inlet nut, and the water line, from the toilet tank, or perform such other operations as are appropriate.

What is claimed is:

1. A tool for attaching and removing water inlet nuts, comprising:
an elongated body, said body having a first end and a second end, said elongated body having a split formed therein of sufficient width to accept a water line of a toilet there between, said split extending continuously along a length of said elongated body from said first end to said second end,
said first end being adapted to accept a water inlet nut for a toilet, said water inlet nut having at least six bosses about a circumference of said water inlet nut, said first end having a generally circular void therein, with said generally circular void of said first end having at least five arcuate slots formed about a circumference of said void, with each of at least three of said at least five slots being equidistant from an adjoining slot on either side thereof, and
said second end being adapted to accept a second water inlet nut for said toilet, said water inlet nut having at least two blades formed about a circumference of said water inlet nut, said second end having a generally circular void therein, with said generally circular void having at least two slots formed about a circumference of said generally circular void of said second end, each of said at least two slots being 180 degrees from a remaining slot of said at least two slots.

2. A tool for attaching and removing water inlet nuts as described in claim 1, wherein said body has a generally circular outside diameter.

3. A tool for attaching and removing water inlet nuts as described in claim 1, wherein said first end is enlarged relative to a remainder of said body.

4. A tool for attaching and removing water inlet nuts as described in claim 1, wherein said body has a generally circular void formed between said first end and said second end, and wherein said generally circular void formed between said first end and said second end is communicates with said generally circular void of said first end and said generally circular void of said second end.
